(19) United States
(12) Patent Application Publication
(10) Pub. No.: US 2026/0001412 A1
(43) Pub. Date: Jan. 1, 2026

(54) SUPER EV

(71) Applicant: Dr. NakaMats Innovation Institute, Setagaya-ku Tokyo (JP)

(72) Inventor: Yoshiro NakaMats, Setagaya-ku, Tokyo (JP)

(21) Appl. No.: 18/879,449

(22) PCT Filed: Aug. 28, 2023
(86) PCT No.: PCT/JP2023/030914

§ 371 Date: Dec. 27, 2024

(30) Foreign Application Priority Data
Sep. 5, 2022 (JP) 2022-141072
Feb. 22, 2023 (JP) 2023-026782

(51) Int. Cl. B60L 50/40; B60K 1/04; B60L 8/00

(52) U.S. Cl. CPC B60L 50/40; B60K 1/04; B60L 8/003

(57) ABSTRACT

The objective of the present invention is to eliminate a drawback of conventional EVs. Conventional EVs are not profitable. In order to resolve this problem, structural components and the body of the EV are formed using capacitors, and are used both as a formed body and for electricity storage.

### TECHNICAL FIELD

The “super” spoken of here means something that is significantly superior to anything preceding it.

“EV” refers to electric vehicles, snowmobiles, trains, ships, icebreakers, airplanes, chargers, household electrical appliances, and other electrical equipment.

### PRIOR ART

EVs are better because they do not produce carbon.

Gasoline prices are rising.

This is a positive outcome for companies that are decarbonizing.

Companies are producing EVs for reasons such as the fact that batteries speak to issues of people, things, and money, and they generate a huge new market for data. On the other hand, they have major drawbacks that will be discussed below.

### OUTLINE OF THE INVENTION

### Problems to be Solved by the Invention

The inventor of this invention lectures at MIT (Massachusetts Institute of Technology), which is the world's summit of technological research, and in discussions about energy among energy specialists have concluded that “current EV electric vehicles are no good”.

The reason is that known batteries “have a low number of charge cycles and therefore high amortization costs, making them unprofitable and not cost competitive with gasoline-powered vehicles, and moreover batteries do not have zero carbon emissions.”

In recent years, lithium-ion batteries have been developed and companies have been actively producing EVs that use these batteries. However, this is problematic because the metal used for lithium-ion batteries can only be extracted in certain countries.

Moreover, this problem cannot be resolved in the same way even with solid-state batteries.

The present invention is a breakthrough invention that solves all of the aforementioned problems. However, this is problematic because the metal used for lithium-ion batteries can only be extracted in certain countries.

Moreover, this problem cannot be resolved in the same way even with solid-state batteries.

The present invention is a groundbreaking invention invented to solve all of the aforementioned problems.

### Means of Solving the Problems

The inventor has replaced the supply of electricity from batteries to capacitors. However, while capacitors have many advantages over batteries as described below, they also have disadvantages. The present invention eliminates these drawbacks as well.

### Effects of the Invention

As indicated in [0010] below, the use of low-cost rare metals, rapid recharging, and extended driving range will facilitate EVs, airplanes, ships, and household equipment such as never seen before.

### BRIEF DESCRIPTION OF THE DRAWINGS

FIG. 1: Shows the basic unit of the capacitor group of the present invention, (A) and (B) are diagrams of two different capacitor capacitance units

FIG. 2: Illustration of a first embodiment of the invention

FIG. 3: Illustration of a second embodiment of the invention

FIG. 4: Illustration of a third embodiment of the invention.

FIG. 5: Illustration of a fourth embodiment of the invention

FIG. 6: Illustration of a fifth embodiment of the invention.

FIG. 7: Illustration of a sixth embodiment of the invention.

FIG. 8: Illustration of a seventh embodiment of the invention.

FIG. 9: Illustration of an eighth embodiment of the invention.

FIG. 10: Illustration of a ninth embodiment of the invention

FIG. 11: Illustration of a tenth embodiment of the invention.

FIG. 12: Illustration of an eleventh embodiment of the invention.

FIG. 13: Illustration of a twelfth embodiment of the invention

FIG. 14: Illustration of a thirteenth embodiment of the invention.

FIG. 15: Illustration of a fourteenth embodiment of the invention.

FIG. 16: Illustration of a fifteenth embodiment of the invention

### EMBODIMENTS OF THE INVENTION

Comparison of batteries (lithium-ion batteries) with capacitors

TABLE 1
Comparison of packages equivalent to 40 kwh for an EV

| | Batteries | Capacitors |
|---|---|---|
| | (lithium-ion) | (electric double-layer capacitors) |
| Electrical circuits | Charge-discharge control needed | Can be fully discharged, little internal |
| | | loss |
| Use temperature range | −20~+50° C. | −100~+85° C. |
| Charge/discharge cycles | Around 500~1000 | Unlimited |
| Charging time | Several hours | Several seconds (rapid charge |
| | | possible) |
| Current characteristics | Stable voltage | Instantaneous discharge of large |
| | | current possible |
| Deterioration, service life | Deteriorates | Not applicable |
| Safety | Risk of liquid leakage, fire, and | No danger (safe) |
| | bursting | |
| Dangers | Ignition due to impact | Does not ignite due to impact |
| Type of rare metal | Uses lithium and cobalt | Not used |
| Size | Small | Large (about 80 times) |
| Specific gravity | Large (about 2.5) | Small (about 1.5) |
| Manufacturing | Low | High |
| productivity | | |
| Cost | High | Low |

As shown in Table 1 above,

(1) First, in terms of electric circuits, batteries do not fully charge and discharge electricity, while a capacitor fully charges and discharges electricity, which means that it has very high energy efficiency.

(2) Next, the operating temperature for batteries ranges from −20° C. to +50° C., while that for capacitors is from −100° C. to +85° C. Therefore, batteries cannot be used in extremely cold locations or in refrigerated vehicles (interior). However, capacitors can also be used in extremely cold locations and in snowmobiles, and freezer trucks. Also, batteries battery can only be used at +50° C., so they cannot be used in extremely hot or heated locations. However, capacitors can also be used in location with extreme heat or where they are heated.

(3) Batteries can be charged and discharged 500˜1000 times, while capacitors can be charged and discharged unlimited times. In other words, batteries are associated with costs since they are no longer usable after 500˜1,000 cycles. On the other hand, capacitors are unlimited, i.e.

$$Power cost \div ∞ = 0$$

This is the major focus of the invention.

(4) Charging can take several hours with batteries, but capacitors can be charged rapidly in seconds.

(5) The current characteristics of capacitors are such that they can instantaneously discharge large amounts of current.

This means that the drive efficiency of the motor is increased and thus less energy is required to move the vehicle.

(6) When it comes to deterioration and service life, batteries deteriorate while capacitors do not. Thus, batteries soon become unusable while capacitors will last for a long time.

(7) In terms of safety, batteries have the risk of leakage, ignition, and rupture, while capacitors are safe and without risk.

(8) A well-known example of this hazard is the fire that broke out on a Boeing 787. The cause were the impacts incurred during takeoff and landing of the 787. Batteries (lithium-ion batteries) cannot be used in aircraft or the like because of a fatal defect that causes them to leak and catch fire upon impact.

(The inventor of the present application has invented a patent (U.S. Pat. No. 6,362,300) that solves this problem.)

In contrast, capacitors do not ignite when subjected to impacts, so they can be used in aircraft, vehicles, and many other applications without limitation.

(9) In terms of rare metals, batteries (lithium-ion batteries) require the use of such rare metals. Since capacitors do not need rare metals, they are not associated with problems such as the price increase of rare metals and the inability to produce storage batteries because they are not available, making them environmentally friendly.

(10) Manufacturing productivity is high because capacitors are simple in structure and easy to produce.

(11) The specific gravity of batteries is around 2˜2.5, but that of capacitors is around 1˜1.5. For aircraft, vehicles, and other mobile devices, it is important to make them as light as possible, and the low specific gravity of capacitors is very effective in reducing energy consumption.

(12) While battery (lithium-ion batteries) prices are high, capacitor prices are low.

Almost all of the above is true of capacitors, which are thus superior to batteries. If the capacitor is an electric double-layer capacitor (EDLC), the amount of electricity that can be stored will be even greater.

The only drawback to capacitors, however, is their large size.

If a capacitor is used as a battery, the key point of the invention is how to deal with their large size.

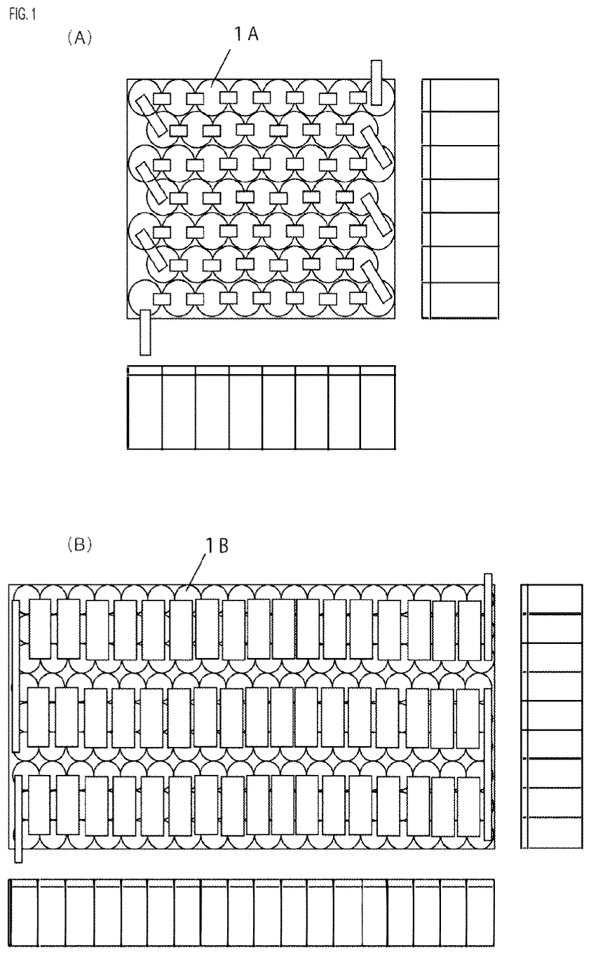

FIG. 1 shows an example of the basic unit of the invention. Figure (A) 1A shows a unit of 53 cylindrical-shaped (approx. 6 cm diameter) capacitor cells with a voltage of 2.8V and a capacitance of 3.5 Wh. FIG. (B) 1B is a diagram of 16 units of 2.5 V voltage, 2.5 Wh capacitance cylindrical-shaped (approx. 4 cm diameter) capacitor cells.

Capacitor 1 is a capacitor which consists of an electrode such as aluminum foil and an insulator such as paper, plastic, or the like, which is wound around the electrode, which is combined with many other capacitors in series and/or parallel.

### First Embodiment of the Invention

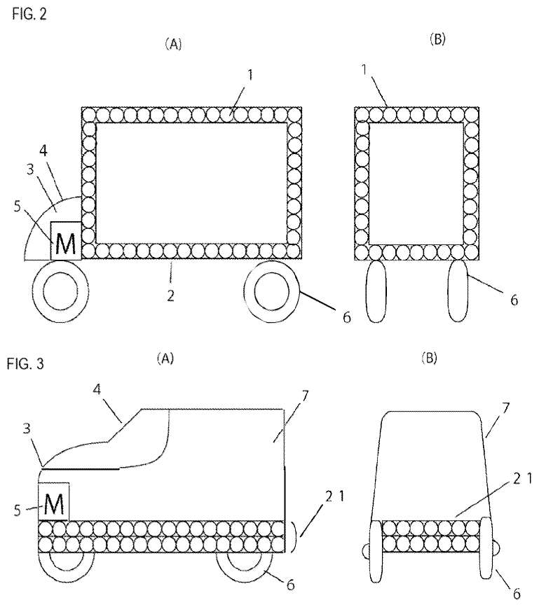

FIG. 2 shows a first embodiment of this invention wherein (A) is a side view and (B) is a cross-sectional view thereof.

To overcome the problem of large size, the problem is solved by forming the structure and body of the cart, etc., with capacitors. As shown in FIG. 2, this solution is first applied to refrigerated vehicles. The reason for the use of capacitors in a refrigerator vehicle is that capacitors can operate at temperatures lower than those used by batteries, as indicated previously.

As shown in FIG. 2, the capacitors 1 of the refrigerated vehicle are box-shaped, and a motor 5 and double doors are disposed to the rear of the capacitors. This is the first form of the structure that is placed on top of the driver's compartment 4, tires 6 and other drive units. 4 is the driver's windshield.

### Second Embodiment of the Invention

FIG. 3 illustrates a second embodiment of the invention.

The first embodiment of FIG. 2 uses an ordinary frame 2, i.e., a ladder type, backbone type, X type, etc. cart, but in the second embodiment shown in FIG. 3, the invention frame 21 is a structure in which capacitors or other storage group is combined into a planar shape, and several of these planar forms are stacked to strengthen the rigidity to form a frame 21.

The invention can be included in other shapes, such as ladder, spine, X-shape, etc., instead of a planar shape.

The car body 7 is placed on top of this frame 21 of this invention. (A) is a side section view and (B) is a cross-sectional view.

The body 7 can be made of ordinary steel or aluminum, or the body 7 can consist of capacitor sheets formed by laminating aluminum as a flat capacitor without winding the capacitor.

### Third Embodiment of the Invention

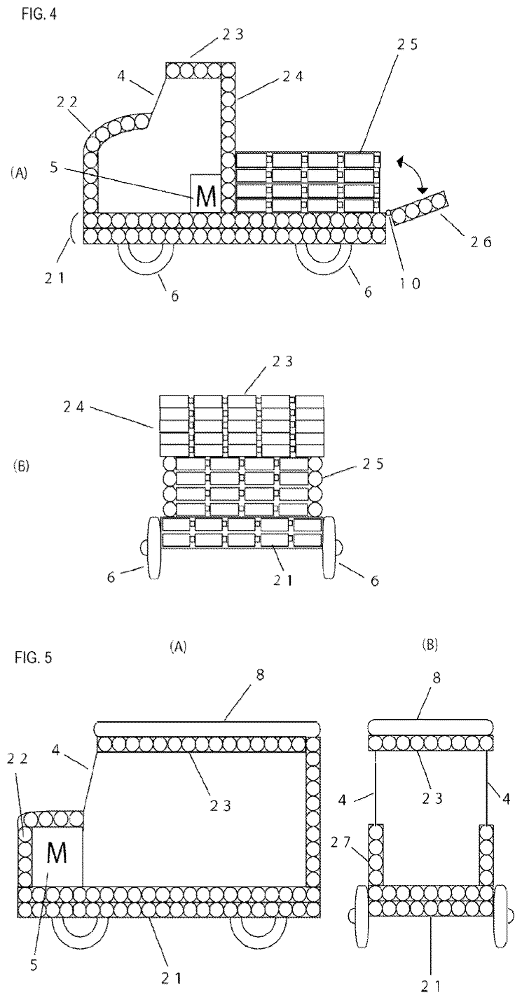

FIG. 4 shows a third embodiment of the invention.

This is an example of a pickup truck, the best-selling truck in the U.S., manufactured with the present invention. The cargo bed 25, cargo door 26, frame 21, cab 22, 23, and 24 are all structures built of capacitors. 10 is the opening and hinge of the tailgate 26.

### Fourth Embodiment of the Invention

FIG. 5 illustrates a fourth example of this invention.

This is an implementation of the invention in a boxcar, with part 27 of the body sides, 22 of the motor protection section (crash mitigation section), and 23 of the ceiling as structures comprised of capacitors, and 8 solar cells in the ceiling. 4 is made of glass making it visible from the exterior.

(A) is a horizontal view and (B) is a vertical view.

### Fifth Embodiment of the Invention

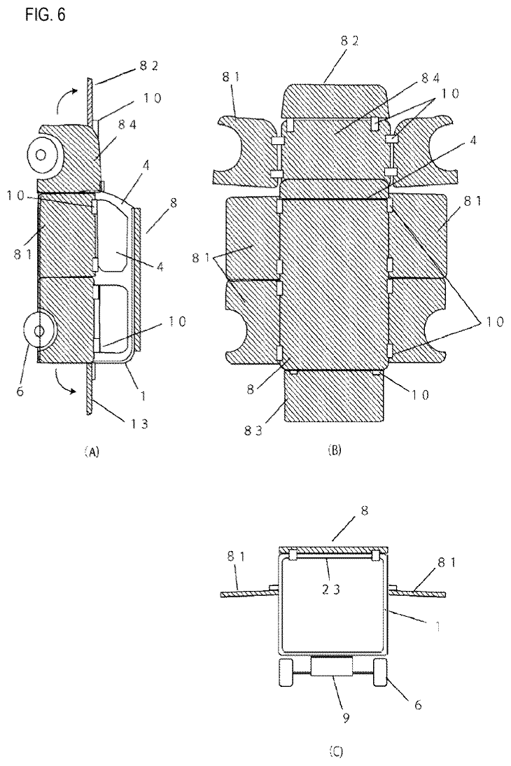

FIG. 6 shows a fifth embodiment of the invention, a structure comprising solar panels 8 not only on the ceiling but also on the sides 81, front 82, rear 83, and 84 on the hood, which can be expanded horizontally with the hinge 10, and the main body 1 (including the ceiling 23) is made of capacitors.

In this way, the hinges 10 allow the solar panels 81, 82, and 83 to be deployed horizontally as shown in FIGS. 6 (B) and (C) to absorb and store a large amount of solar energy in the capacitor body 1 when the car is parked.

Even if it is not a capacitor body 1, it is included in this invention in the case of a conventional car or the like.

### Sixth Embodiment of the Invention

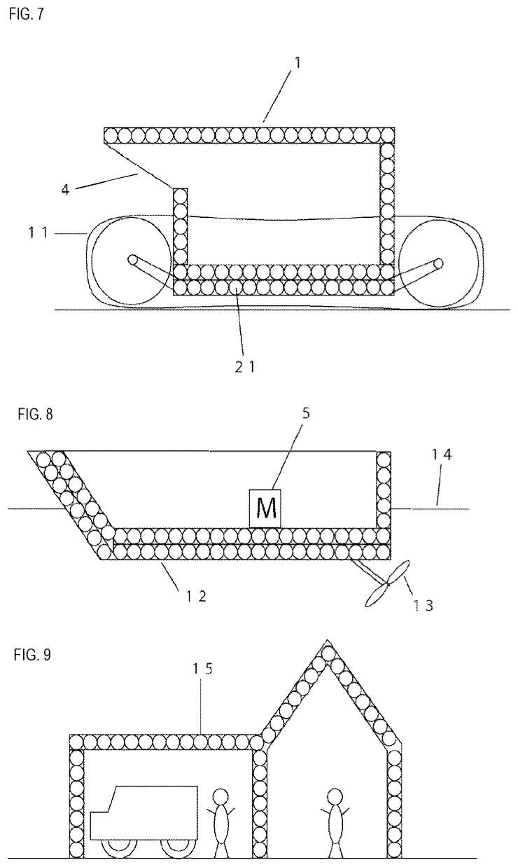

FIG. 7 shows a sixth embodiment of the invention, in which the invention is applied to moving vehicles such as snowmobiles, tanks, bulldozers, excavators, etc. that run on caterpillars 11, wherein the frame 21 and body 1 are comprised of capacitors, which operate the motor.

### Seventh Embodiment of the Invention

FIG. 8 shows the structure of the invention on an icebreaker, taking advantage of the low-temperature tolerant properties of the invention.

This is the seventh embodiment in which the motor is turned by a capacitor.

This invention includes ordinary ships as well as icebreakers. The invention also includes vessels that are not powered by electric motors but by other driving power.

### Eighth Embodiment of the Invention

FIG. 9 shows an eighth embodiment of the present invention, which is a house made of a structure in which the house 15 is made of capacitors.

### Ninth Embodiment of the Invention

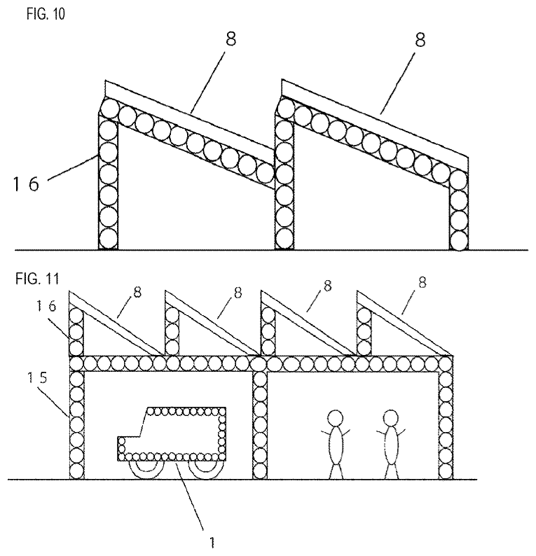

FIG. 10 shows a ninth embodiment of the invention in which the mounting structure 16 supporting the solar panels 8 is a capacitor structure.

### Tenth Embodiment of the Invention

FIG. 11 shows a tenth embodiment of the present invention, in which each household serves as a power generation facility. The structure consists of a solar panel on the roof, a mounting structure to support the solar panel, a capacitor housing, and a vehicle.

When combined with a conventional home power plant, this system becomes a giant power generation plant that is used for day and night electricity use, eliminating power outages, saving electricity, and eliminating excess electric power, thereby contributing to SDGs.

The system also provides energy for the vehicle and serves as storage when not in use.

### Eleventh Embodiment of the Invention

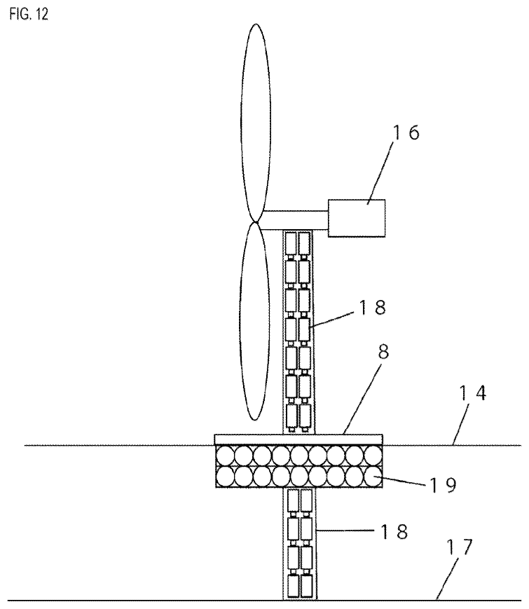

FIG. 12 shows an eleventh embodiment of the present invention, in which the support 18 and a floating body 19 of an offshore power generation system 16 comprise the present invention capacitor structures.

The figure shows a structure which is embedded in the seafloor 17, but it can also be a floating type.

### Twelfth Embodiment of the Invention

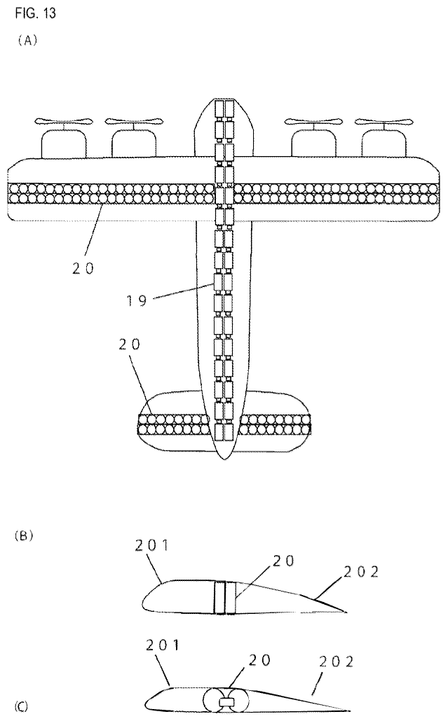

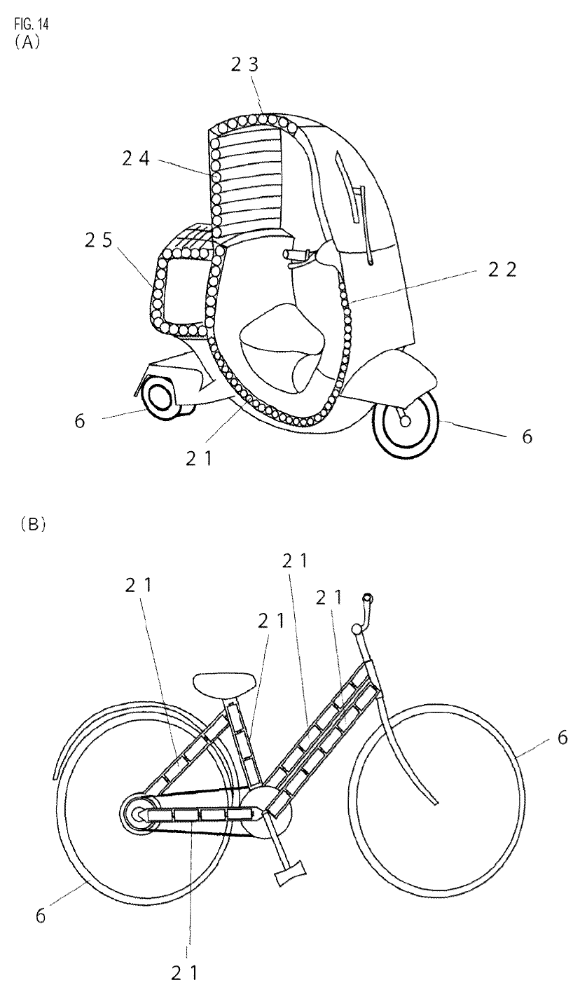

FIG. 13 shows a twelfth embodiment of the invention used for aircraft. The capacitor can be used not only in FIG. 13 (B) but also vertically, horizontally as shown in FIG. 13 (B), or a mix of the two.

201 is the leading edge of the wing and 202 is the trailing edge.

### Thirteenth Embodiment of the Invention

FIG. 14 shows a thirteenth embodiment of the present invention, which is a capacitor structure for a two-wheeled vehicle (or three-wheeled vehicle) that is straddled by a person, such as a human-powered bicycle, a human-powered electric bicycle, a motorized bicycle, a motorcycle, or a scooter, which includes a frame 21, a capacitor ceiling 23, a cargo bed 25, and a wall 24. (A) is an embodiment in which a capacitor is installed in a covered scooter (three-wheeler), and (B) is an embodiment in which a capacitor is installed in a bicycle.

According to the thirteenth example of this invention, the use of capacitors in the frame and other parts at the bottom between the two bases of the two wheels allows for a stable ride without wobbling.

### Fourteenth Embodiment of the Invention

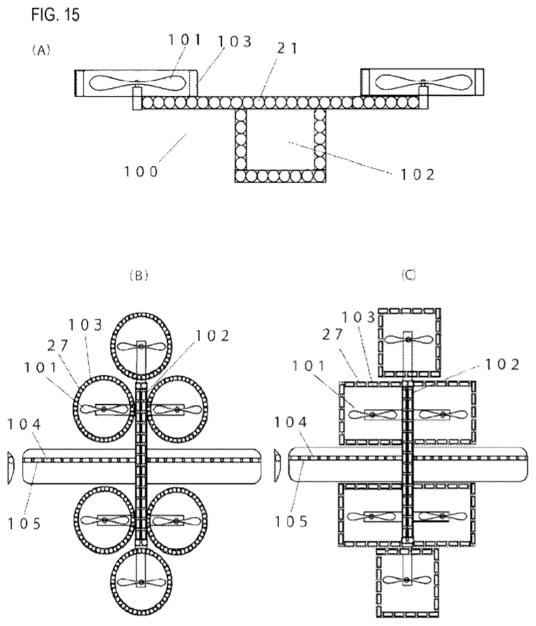

FIG. 15 shows a fourteenth embodiment of the invention with capacitors in a drone 100. (A) is an embodiment in which the frame 21 and propeller guard 103 of the drone 100 are structures comprised of capacitors. (B) and (C) are embodiments in which the drone is fitted with wings 104, and in which the wing spars 105, frame 21, and propeller guard 103 are structures comprised of capacitors. This is an embodiment in which the propeller guard is a structure with the capacitor facing sideways is (C).

According to the fourteenth embodiment of the invention, the carrying case 102 can be used in combination with a frame, etc. to load luggage and a camera, making it possible to transport a significant amount of luggage for a long time and to shoot in distant places. The wing spars comprise capacitors, which allows the aircraft to fly for long periods of time and to move at high speeds in level flight.

### Fifteenth Embodiment of the Invention

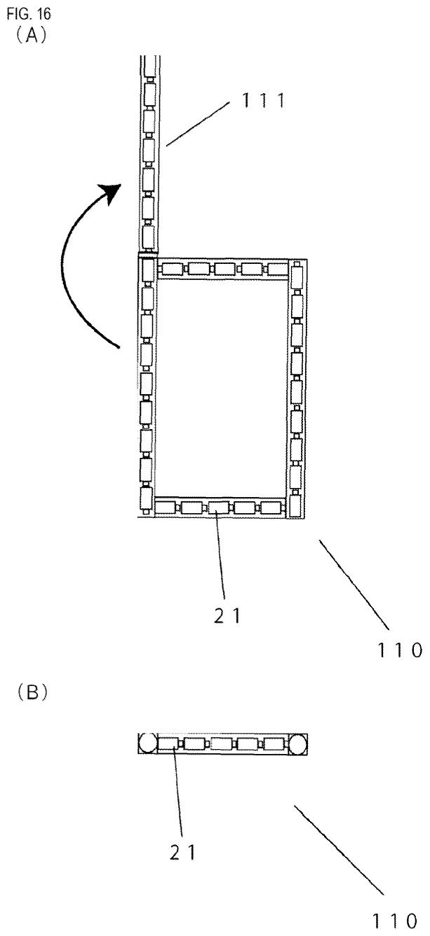

FIG. 16 shows the fifteenth embodiment of the invention, which is a structure with a capacitor in the frame 21 and grip 111 of a smartphone 110.

The grip 111 can be folded into the side of the smartphone.

The grip 111 can also serve as an antenna.

(A) shows the front view of the grip 111 when it is extended as indicated by the arrow C, and (B) shows a top view thereof.

According to the fifteenth embodiment of the present invention, the problem of insufficient battery capacity in smartphones, which prevents them from being used for long periods of time, is easily resolved.

### Sixteenth Embodiment of the Invention

The sixteenth embodiment of the present invention is a structural building in which a capacitor storage battery and transmission lines are directly connected and the capacitor battery is about to store electric power.

This approach makes up for shortfalls in electricity supply and demand and ensures stable electricity usage.

In addition to the above embodiments, various other applications and variations of the present invention are possible, such as motorcycles, scooters, human-assisted electric bicycles, courier service luggage trolleys, etc., all of which are included in the present invention.

### INDUSTRIAL APPLICABILITY

This revolutionary power supply has tremendous industrial potential.

### EXPLANATION OF SYMBOLS

1) A body that combines several capacitors and other electrical energy and storage elements to serve as both a structure and energy storage body, in FIG. 1, a freezer.
1A) Cylindrical capacitor cells that make up the basic unit
1B) Cylindrical capacitor cells of different capacities that make up the basic unit
2) Frame
21) Capacitor Frame
22 Capacitor Front
23) Capacitor ceiling
24) Capacitor wall
25) Capacitor cargo bed enclosure
26) Capacitor rear enclosure
27) Side guard
3) Driver's seat
30) Driver
4) Transparent window
5) Electric motor
6) Tires (may include electric motors)
7) Frame
8) Solar panel
81) Side solar panel
82) Front solar panel, gearbox or motor
10) Hinge
11) Caterpillar
12) Ship hull built with capacitors
13) Screw
14) Sea surface
15) House built with capacitors
16) Offshore wind turbine generator
17) Sea floor
18) Offshore wind energy storage
19) Aircraft fuselage
20) Capacitor wing spars
201) Wing leading edge
202) Wing trailing edge
100) Drone
101) Propeller
102) Carrying case for luggage and camera
103) Capacitor propeller guard
104) Wings installed on drone
105) Drone capacitor wing spars
110) Smartphone
111) Grip

1. A super EV characterized by the combined use of a capacitor for both energy storage and creating a formed body.

2. A super EV characterized by the fact that it eliminates the disadvantages of capacitors and makes the most of their advantages by using capacitors to create the EV's structure.

3. The super EV of claim 1 used with a freezer, an automobile frame, a truck bed, a van, a car body, a snow vehicle, a general passenger vehicle, an icebreaker, a general ship, a general residence, a solar panel rack, a household generator, offshore power generation, or an aircraft.

4. The super EV of claim 1 used in a device that deploys solar panels in a vertical direction and extends horizontally to absorb solar energy efficiently.
